(19) United States
(12) Patent Application Publication
(10) Pub. No.: US 2007/0239524 A1
(43) Pub. Date: Oct. 11, 2007

(54) ENHANCED INTERACTIVE ADVERTISING

(76) Inventor: Neaman Tewahade, Longmont, CO (US)

Correspondence Address: GLENN L. WEBB, P.O BOX 951, CONIFER, CO, 80433, US

(21) Appl. No.: 11/278,534

(22) Filed: Apr. 3, 2006

(51) Int. Cl. G06Q 30/00

(52) U.S. Cl. 705/14

(57) ABSTRACT

An automated system for allowing a viewer of an online advertisement to connect via a telephone call with the advertiser at a requested time. The system provides a clickable connect button on a static as well as a dynamic landing page advertisement. The viewer simply clicks on the connect button which then causes the system to request the call back telephone number of the viewer and a time to receive the call from the advertiser. The system then schedules the call back and at the requested time connects the viewer and the advertiser.

### FIELD OF THE INVENTION

This invention relates to the field of interactive advertising and more particularly to the field of online advertising.

### BACKGROUND OF THE INVENTION

Advertising has migrated from traditional media, such as newspapers, magazines, television and radio to online advertising such as on the Internet. Online advertising provides information to potential customers about products and services. Online advertising has become increasingly more sophisticated allowing targeted advertising by inferring the interest of an online user based on their search query, websites that have been visited, downloaded files or other relevant information. One problem with these online advertisements is the lack of user interaction. The advertising entity is unable to determine the level of user interest in the advertisement. The user may be interested in the product or services being offered, but is unable to directly contact the advertising entity online for information except by email or by visiting the advertiser's online website, if they have one, retrieve contact information and attempt to telephone the advertiser for additional information.

There have been previous attempts to solve this problem. One such attempt is disclosed in U.S. Patent Application Publication 2006004627. This published application discloses a “click-to-connect” system that allows a user to click a button on an online advertisement that dials the advertiser telephone number. This system requires a computer system that has call functionality or a mobile telephone with Internet access.

Ingenio also has a type of pay per call service. This service provides a toll free telephone number that appears in the online advertisement. The user calls this number which has been assigned to a particular merchant. The caller is forwarded to that merchant.

There is no system presently that will allow a user to connect via telephony with a merchant via an online advertisement through any internet connection.

### SUMMARY OF THE INVENTION

The present invention solves these and other problems by providing systems and methods that allow a viewer of an online advertisement to connect directly with the advertiser. The system and processes of the present invention may be used regardless of whether the viewer's online browsing device supports telephony. The system and processes enable a viewer of an online advertisement to have live telephony contact with the advertiser at a time of the viewer's choosing.

The advertiser also obtains a warm interested lead in their products and services. The advertiser also is able to obtain an easily verifiable accounting of the number of calls generated and delivered to the advertiser.

The system and processes of a preferred embodiment of the present invention enables advertisers to create an online advertising campaign without the know how and internet savvy required to manage such a campaign. The advertiser need not have an existing online presence. A third party service provider will design and manage the advertising campaign and the technology of the “Connect-Me” system.

The system of a preferred embodiment of the present invention provides an online advertisement that has a clickable connect button. A viewer that is interested in more information or ordering the advertised product or services merely clicks on the button as instructed. The button will activate a request for additional information that allows the viewer to input their call back telephone number and time for receiving the call from the advertiser. The requested time and telephone number is then scheduled with the advertiser. At the requested time, the system connects the viewer and the advertiser through a telephony interface.

The telephony interface of a preferred embodiment of the present invention receives the viewer's call back number and requested time, automatically schedules the time, sends an acknowledgement message to the viewer and sends status messages to the viewer and the advertiser. The interface then automatically connects the viewer and the advertiser over the telephone network at the scheduled time.

A preferred embodiment of the present invention enables a third party service provider to provide the call back service to advertisers. The system of this embodiment provides an interface, such as a web based user interface that allows an advertiser to register for the service online. The advertiser provides certain information such as the call back telephone number to be used for the advertisement, billing information, and information about the products and services to be advertised. Suggested keywords about the products and services can also be submitted as well. The service provider then generates an online advertisement from this information. The online advertisement, in a preferred embodiment, may also provide a landing page for the products and services. The clickable connect button may be incorporated in either the advertisement or the landing page.

The system in a preferred embodiment may also provide an online advertising campaign for the advertiser. This campaign may include an ad listing, keywords and a landing page. The service provider can then place this advertising campaign on relevant search engines, advertising networks or other online advertising venues.

In another preferred embodiment, the system provides a dynamic landing page. The dynamic landing page allows an advertiser to directly change the text and graphics on the landing page.

These and other features of the present invention will be evident from the ensuing detailed description of preferred embodiments and from the drawings.

### BRIEF DESCRIPTION OF THE DRAWINGS

FIG. 1 is a schematic diagram of a system of a preferred embodiment of the present invention.

FIG. 2 is an illustration of a user interface screenshot for the advertiser to subscribe to the service of FIG. 1.

FIG. 3 is an illustration of a landing page with the clickable connect button.

FIG. 4 is diagram of the workflow of the system of FIG. 1.

### DETAILED DESCRIPTION OF PREFERRED EMBODIMENTS

The present invention provides a system for allowing interactive contact between a merchant and an online consumer. A preferred embodiment of this system is described herein for explanatory purposes. It is to be expressly understood that this exemplary embodiment is provided for descriptive purposes only and is not meant to unduly limit the scope of the present inventive concept. Other embodiments and uses of the present invention are included in the claimed inventions.

The system of a preferred embodiment of the present invention provides an automated call-back telephony system that enables a viewer to connect interactively with a merchant through an online advertisement. The viewer is able to receive a live telephone call from the merchant while the merchant receives an active lead who is a consumer interested in the products or services of the merchant. This system can be used with any system with internet browsing capability.

In a general overview, a third party service provider creates a business advertisement on behalf of the merchant that is placed with an online advertisement company. The advertisement includes a single web page that contains a description of the product or service of the merchant commonly referred to as a landing page. The landing page includes a “Connect-Me” button prominently featured. The “Connect-Me” button includes instructions to the viewer of the landing page to click on the button to be connected to the merchant. The viewer is an end-user who is directed to the landing page by a keyword query on a search engine, advertising network or other type of online advertising service. The viewer clicks on the connect button causing a pop-up window or webpage to appear. The pop-up window or webpage directs the viewer to input certain information that is relevant to the merchant. This information includes the viewer's call back telephone number and a time to receive a call back from the merchant. Additional information may also be included such as the product or service of interest, geographical location of the viewer and other information that may be relevant to the merchant.

The system will then schedule the telephone call between the merchant and viewer and relay the relevant information to the merchant. The system then automatically connects the viewer and merchant at the scheduled time via telephony.

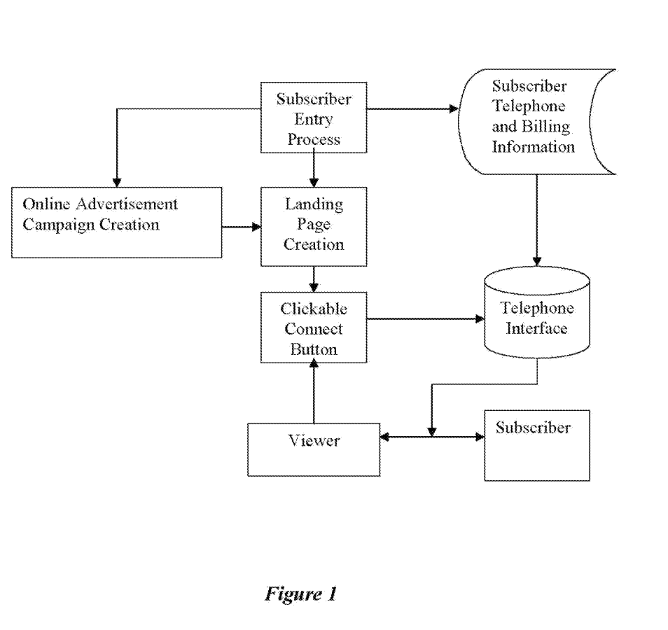

More specifically, the system of this preferred embodiment uses four major components as shown in FIG. 1. These four components include a web based subscriber entry process; a landing page; online advertisement and distribution process; and an automated telephony interface. These four components define the system to enable a viewer to interactively connect with the merchant.

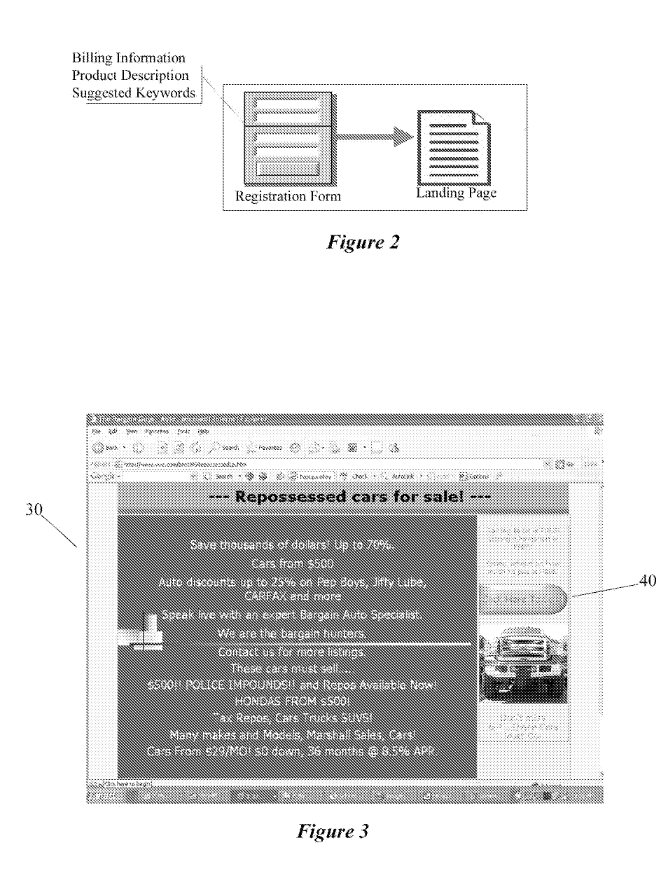

The web based subscriber entry process provides a user interface such user interface 20 shown in FIG. 2 to allow the merchant to register for the service. The registration process includes profile and contact information. This information identifies the merchant's billing information; the keyword(s) to be monitored; the description of the products or services and the callback number of the merchant. Information relevant to creating a landing page is also provided by the merchant at this time.

The landing page is the specific web page that a viewer will ultimately reach after clicking on the initial online advertisement. The initial online advertisement is the advertisement or ad campaign as discussed in greater detail below. The landing page will include a clear and concise description of the product or service being advertised. In this preferred embodiment, the landing page is constructed from the information inputted by the merchant during the registration process.

The landing page can have more than one section in the layout. One section is a static portion of the page where it can describe the product or service in graphical presentation. This section may or may not change during the life of the ad-campaign. The second portion within the landing page layout will be a textual display that can additionally describe the service or product. The implementation of the second portion of the layout can be via a standard HTML script. However, the advertiser will have the capability to login into their account, enter the text or description online, and the system will automatically load it into the landing page during upload. This feature, will allow the advertiser to add current information about the product or service, such as coupon, promotional services, Sale Price, etc, dynamically. The landing page, such as the landing page 30 shown in FIG. 3, also includes a connection button 40. The connection button 40 is a call to action button which the viewer clicks to request a call back service.

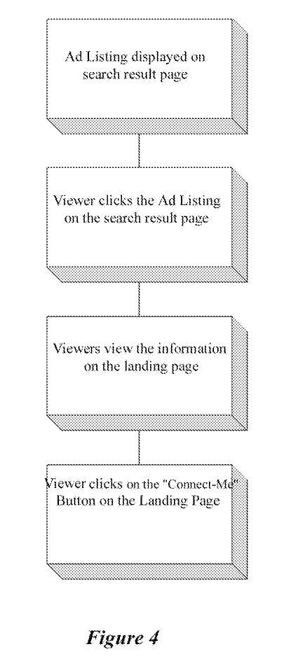

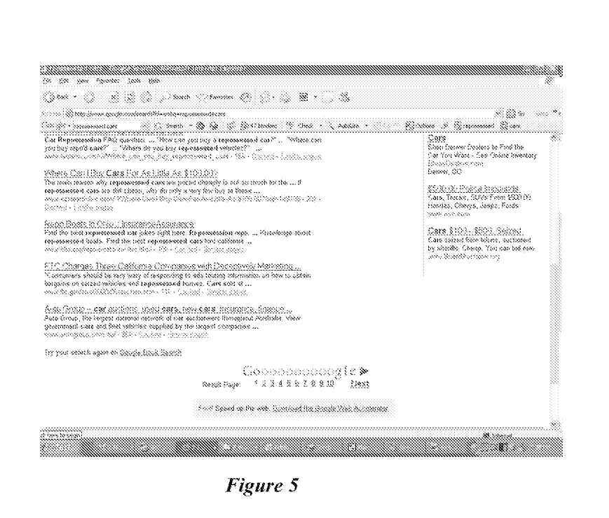

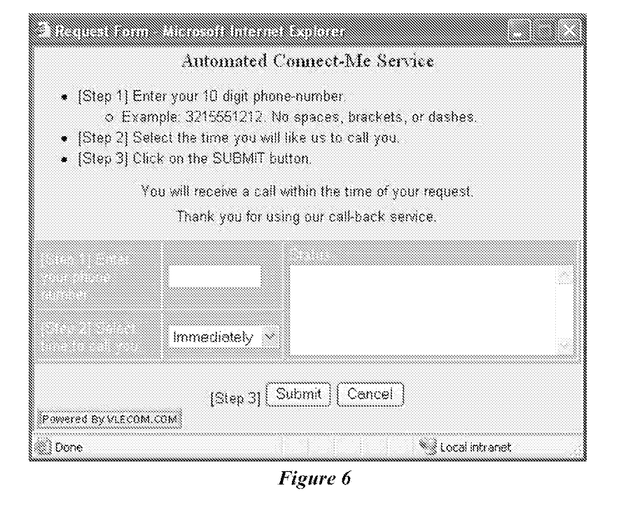

The online advertisement and distribution process provides the methodology as shown in FIG. 4 in this preferred embodiment that places the online advertisement in such a manner to enable the advertisement to be found by an interested viewer. This process starts with an ad-listing. An “ad-listing” is a clipping of an eye-catching phrase that includes the ad-title and brief description of the product or service. The description within the ad-listing is no more than two lines, where each line is approximately 50 characters wide. The ad-listing is the item that is displayed within a search engine return page as a result of a key-word match or a context match. Usually an ad-listing can be displayed either in the very top of a page or on the right or left side of the page and is commonly referred as a “sponsored link.” If the ad-listing is of further interest to the end-user, the end-user can click the title of the ad-listing to go to the landing page. Every time an ad-listing is displayed within a search engine result page, it is referred as an “Impression”. Similarly, when an end-user clicks the ad-listing title to jump to the landing page, it is referred as a “Click-Thru”. Upon reaching the landing page the viewer may decide to place a “Connect-Me” request by clicking the “Connect-Me” button. The process will convert the viewer to be referred to as a “warm lead” and identify this stage in the process a “Conversion”.

Once the landing page and the ad-listing are created, the service will identify and select a set of keywords that closely describe or match the product or service of the advertiser. Based on the respective values the service provider will place a bid for each key-word depending on its relevance to the advertisers' product. The process of bidding for key-words is a broad subject and will not be fully addressed within the scope of this invention. Simply put, it is a process that involves bidding for search key words or terms, to get as close as possible to the #1 ranking spot in the search engine result page. Generally, the higher the bid or the higher the relevancy of the ad, the higher the ranking. Each time someone clicks on the ad-listing link, the service provider pays the bid amount. Bids for each keyword can range from $0.10 cents a click to more than $3.00, depending on the popularity of the keyword. Periodic reports are generated to track the success of the keyword selections. Once an ad-listing is created, key-words selected, and bids are submitted, the ad-campaign is activated and is distributed to all affiliates. It is to be expressly understood that other process of creating and placing online advertisements may also be used as well.

The system uses an automated telephony interface to implement the interaction between the viewer and the merchant. A preferred embodiment of the present invention provides an automated telephony interface (ATI) process is that runs within the VLEC Communications VPC-9000 telephony switching framework. This process is a perpetual message listener service that is waiting for an incoming message from the landing page telephony window. Upon populating the call-back information, when a viewer clicks the submit button, the ATI process sends an event triggering message to the telephony process. The ATI process also sends back an acknowledgment message to the viewer stating that the request has been submitted. The process parses and checks the viewer's call-back information, authenticates the user account, and prepares a telephony action message. Before sending the dial-out instruction, the ATI process checks the “time-to-call” (TTC) requirement. If the TTC is acceptable then the process sends the viewer's call-back number and the advertiser's call-back number to the VPC-9000 telephony switch. The telephony switch software architecture is built as a finite-state-machine. It calls the viewer and the advertiser and when both parties are on-line it will cross-connect the two together.

In summary as shown in the diagram of FIG. 1, the advertiser will register with the service so that the system will generate the landing page and start an ad-campaign through out the on-line advertising networks. A search engine such as shown in FIG. 5 will display the ad-listing as a result of key-word or context match. The viewer as will click the title of the ad-listing to go to the landing page 30 as shown in FIG. 3. The landing page describes the product or service in a concise format. The landing page also provides the “Connect-Me” button which is strategically placed as a “call-to-action” button. Once the viewer clicks the “Connect-Me” button, a screen as shown in FIG. 6 will request the viewer to enter the call-back number and time to call to clarify how soon the viewer would like to be contacted by the advertiser. After completing the two pieces of information the viewer submits the request. The system returns an acknowledgment to the request by displaying a timestamp when the request is submitted and a call tracking number for reference purposes. Depending on the time to call request the system calls the viewer within few seconds or up to 24 hours later. Upon successfully capturing the viewer, it calls the advertiser and bridges the two.

The system of this preferred embodiment is utilized by a third party service provider. The advertiser registers with the third party service provider as described above. The third party service provider then creates the landing page and ad-campaign. The number of viewers that connect through to the advertiser can be easily monitored and reported. The fees for this service in this preferred embodiment can be either on a subscription basis, or more likely, based on the number of calls generated to the advertisers. These calls are in essence verified warm leads and not merely site viewers.

It is to be expressly understood that other embodiments of the present invention are within the scope of the invention as claimed. The above embodiment is provided for descriptive purposes only and is not meant to limit the scope of the claims.

What is claimed is:

1. A system for enabling a viewer to connect with an advertiser through an online advertisement, the system comprising:
an online advertisement;
a clickable connect button on said online advertisement that allows the viewer to input a call back telephone number and time to call; and
an automated telephony interface that receives the inputted viewer information, schedules a telephone call between the viewer and advertiser and connects the viewer and merchant at the scheduled time.

2. The system of claim 1 wherein said online advertisement includes:
a landing page that describes the product or services being advertised and includes said clickable connect button.

3. The system of claim 1 wherein said online advertisement includes:
a landing page that describes the product and services being advertised;
a dynamically updated section on said landing page for updating information by the advertiser on real-time; and
said clickable connect button on said landing page.

4. The system of claim 1 wherein said clickable connect button further includes:
additional information for the viewer to input in regard to the viewer and the products and services being advertised.

5. The system of claim 1 wherein said system further comprises:
an interface that allows advertisers to register with said system.

6. The system of claim 1 wherein said system further comprises:
an interface that allows advertisers to register with said system by providing information about the products and services to be advertised.

7. The system of claim 1 wherein said online advertisement includes:
an ad-listing for the products and services to be advertised that is placed with online advertising services.

8. The system of claim 1 wherein said online advertisement includes:
an advertising campaign.

9. The system of claim 1 wherein said online advertisement includes:
an ad-listing for the products and services to be advertised;
a dynamic landing page describing the products and services to be advertised; and
a clickable connect button on said landing page for connecting the viewer with the advertiser.

10. The system of claim 1 wherein said online advertisement includes:
an ad-listing for the products and services to be advertised;
keywords for describing the products and services to be advertised;
a landing page describing the products and services to be advertised; and
a clickable connect button on said landing page for connecting the viewer with the advertiser.

11. The system of claim 1 wherein said system further comprises:
an event triggering message that is sent to the automated telephony interface when the viewer clicks said clickable connect button on said online advertisement; and
an acknowledgement message sent to the viewer when the viewer has inputted the information regarding the call back number and requested time for the call back.

12. A method for providing a connection between the viewer of an online advertisement and the advertiser, said method comprising the steps of:
providing an online advertisement describing the products and services of the advertiser;
providing a clickable connect button on said online advertisement that allows the viewer to then input a call back telephone number and a time to call back; and
providing an automated telephony interface that receives the call back telephone number and requested time to call back; and
connecting the viewer and the advertiser at the requested time to call back.

13. The method of claim 11 wherein said method further includes:
providing a landing page connected with said online advertisement; and
providing said clickable connect button on said landing page.

14. The method of claim 11 wherein said method further includes:
providing a request for additional information once the viewer clicks on said clickable connect button.

15. The method of claim 11 wherein said method further includes:
sending an event triggering message to the automated telephony interface when the viewer clicks said clickable connect button on said online advertisement; and
sending an acknowledgement message to the viewer when the viewer has inputted the information regarding the call back number and requested time for the call back.

16. The method of claim 11 wherein said method further includes:
said method is provided by a third party service provider; and
providing an interface that allows advertisers to register with said third party service provider.

17. The method of claim 11 wherein said method further includes:
said method is provided by a third party service provider;
providing an interface that allows advertisers to register with said third party service provider by providing information about the services and products of the advertiser; and
generating said online advertisement from the information about the services and products of the advertiser.

18. The method of claim 11 wherein said step of providing an online advertisement includes:
providing an ad-listing for the products and services to be advertised that is placed with online advertising services.

19. The method of claim 11 wherein said step of providing said online advertisement includes:
providing an advertising campaign.

20. The method of claim 11 wherein said step of providing an online advertisement includes:
providing an ad-listing for the products and services to be advertised;
providing a landing page describing the products and services to be advertised; and
providing a clickable connect button on said landing page for connecting the viewer with the advertiser.

21. The method of claim 11 wherein said step of providing an online advertisement includes:
providing an ad-listing for the products and services to be advertised;
providing keywords for describing the products and services to be advertised;
providing a landing page describing the products and services to be advertised; and
providing said clickable connect button on said landing page for connecting the viewer with the advertiser.
